(19) United States
(12) Patent Application Publication
(10) Pub. No.: US 2008/0149806 A1
(43) Pub. Date: Jun. 26, 2008

(54) PEDESTAL AND PRODUCT COMPRISING THE SAME

(75) Inventor: Hyoung Tae Yoon, Incheon (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 11/877,142

(22) Filed: Oct. 23, 2007

(30) Foreign Application Priority Data
Dec. 20, 2006 (KR) 10-2006-0131309

(51) Int. Cl. F16M 1/00

(52) U.S. Cl. 248/638; 248/676

(57) ABSTRACT

A pedestal comprises a body coupled to a product to support the product, a guide part disposed on the body to guide the product to a coupling location between the product and the body, and a drawer disposed in the body. With this construction, the pedestal enables the product such as a washing machine to be firmly secured to the pedestal while allowing easy detachment of the product therefrom.

### CROSS-REFERENCES TO RELATED APPLICATIONS

The present application claims priority to Korean patent application number 10-2006-0131309, filed on Dec. 20, 2006, which is incorporated by reference in its entirety.

### BACKGROUND OF THE INVENTION

The present invention relates to a pedestal and a product comprising the same, and, more particularly, to a pedestal, which can be firmly coupled to a product with ease, and the product which comprises the pedestal.

In general, a pedestal provides not only accessibility to various products such as display devices and drum washing machines, but also a preservation compartment for various items, providing various conveniences to a user.

In particular, since a drum washing machine typically comprises a drum longitudinally disposed in the machine, and a door hingably coupled to a front side of a body of the washing machine, a user inputs or withdraws laundry into or from the washing machine, standing in front of the washing machine. For such a drum washing machine, the door is positioned at a lower portion of the body of the washing machine, causing the user to suffer from the inconvenience of bending his or her body to input or withdraw the laundry. Thus, the pedestal is generally used to support the washing machine to allow the user to input or withdraw the laundry without bending the body.

In the event where such a conventional washing machine is used on the pedestal, the washing machine can often fall off the pedestal due to vibrations which occur during a washing operation. To solve such a problem, the washing machine is bonded to the pedestal by adhesives in the art. In this case, although the washing machine can be firmly secured to the pedestal by use of the adhesives, there is a problem in that the washing machine cannot be easily detached from the pedestal. Thus, there are needs of the improvement of such a conventional pedestal.

### BRIEF SUMMARY OF THE INVENTION

The present invention has been made according to the foregoing needs, and it is an aspect of the present invention to provide a pedestal, which enables a product such as a washing machine to be firmly secured to the pedestal while allowing easy detachment of the product therefrom, and the product which comprises the pedestal.

It is another aspect of the present invention to provide a pedestal, which is convenient in use and applicable to many purposes, and a product which comprises the pedestal.

In accordance with one aspect of the present invention, a pedestal is provided, comprising: a body coupled to a product to support the product; a guide part disposed on the body to guide the product to a coupling location between the product and the body; and a drawer disposed in the body.

In one embodiment, the guide part may be formed with a coupling aperture through which the body is coupled to the product.

In one embodiment, the product may comprise a securing leg to be coupled to the body of the pedestal through the coupling aperture.

In one embodiment, the product may comprise a securing leg detachably attached to the product such that the securing leg can be coupled to the product through the coupling aperture after separating the drawer from the body.

In one embodiment, the guide part may comprise a support member to support the product to guide the product to the coupling location between the body and the product.

In one embodiment, the support member may comprise a vibration damping pad to absorb vibration of the product.

In one embodiment, the support member of the guide part may be formed with a coupling aperture through which the body is coupled to the product.

In one embodiment, the product may comprise a securing leg coupled to the body of the pedestal through the coupling aperture.

In one embodiment, the product may comprise a securing leg detachably attached to the product such that the securing leg can be coupled to the product through the coupling aperture after separating the drawer from the body.

In accordance with another aspect of the present invention, a product comprises one of the pedestals according to the above embodiments.

In one embodiment, the product may comprise a washing machine.

According to the present invention, the product can be firmly secured onto the pedestal.

Furthermore, according to the present invention, when the pedestal is used to support the product, the pedestal can reduce vibration and noise generating from the product, thereby extending the lifetime of the product.

Furthermore, according to the present invention, since the product is attached to the pedestal without adhesives, separation and coupling between the product and the pedestal can be easily performed.

Furthermore, the pedestal according to the present invention comprises the detachable drawer so that the pedestal can be easily installed or moved.

Furthermore, the pedestal according to the present invention comprises the detachable drawer so that the space in the drawer can be used as a separate receiving compartment.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a perspective view of a pedestal in accordance with one embodiment of the present invention;

FIG. 2 illustrates an exploded perspective view of a coupling structure between a pedestal and a washing machine in accordance with another embodiment of the present invention;

FIG. 3 illustrates a cross-sectional view of a part of the washing machine shown in FIG. 2; and

FIG. 4 illustrates a cross-sectional view of a part of a washing machine in accordance with yet another embodiment of the present invention.

### DETAILED DESCRIPTION OF THE INVENTION

Embodiments of the present invention will now be described in detail with reference to the accompanying drawings. For convenience of description, the present invention will be discussed in conjunction with a pedestal for a washing machine, and a washing machine comprising the same. Herein, the thickness of lines or the dimensions of components constituting the present invention can be exaggerated in the drawings for clearness and convenience. The terms are defined in consideration of the functions of the components in the present invention, and can be different depending on the intentions and usual practices of users and operators. Therefore, definition of these terms must be determined in the context of the overall contents of the specification.

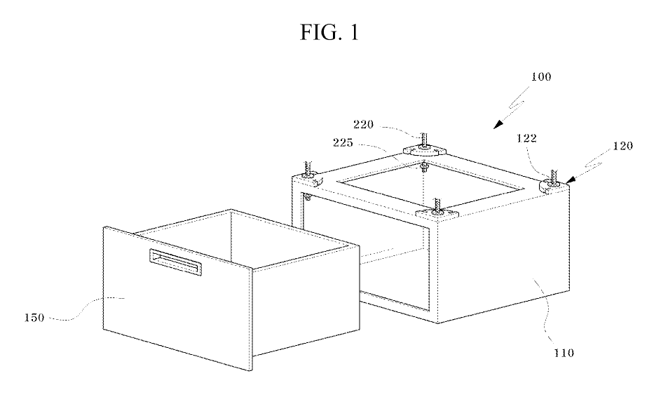

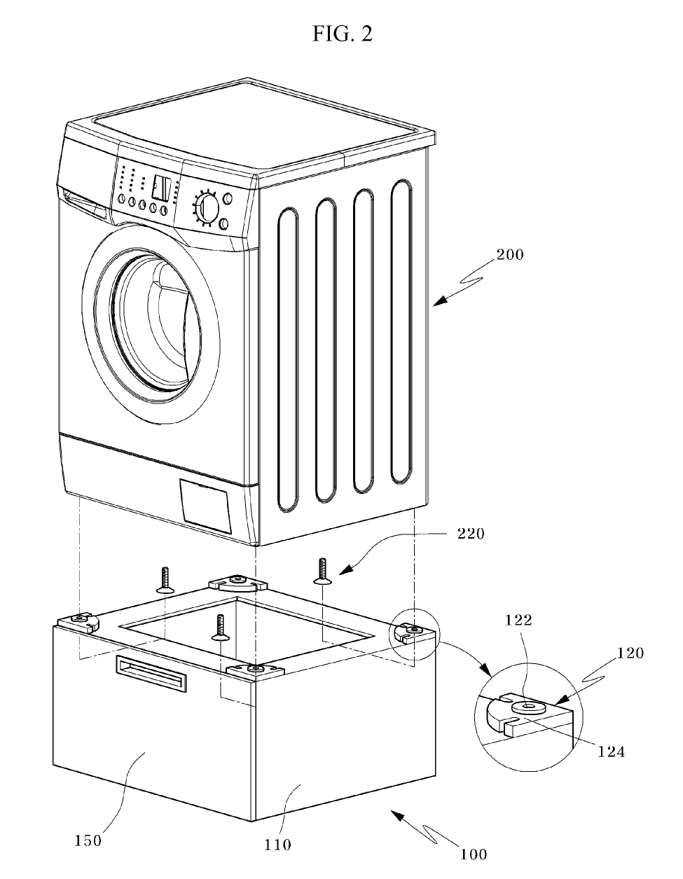

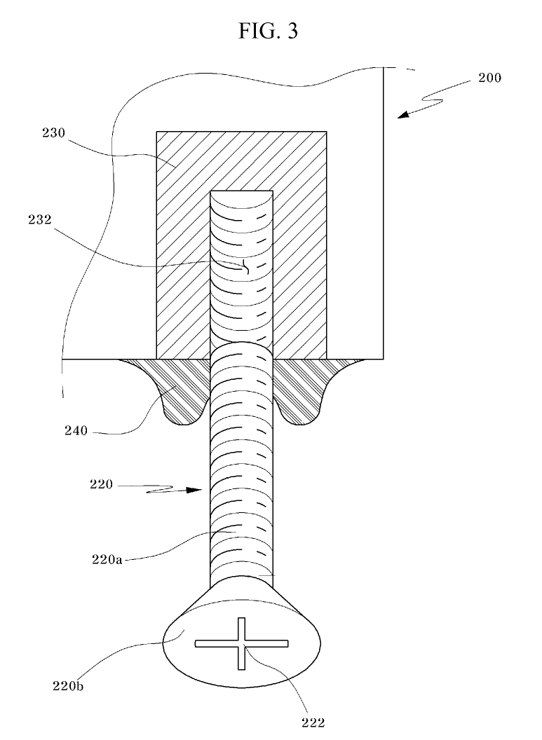

FIG. 1 illustrates a perspective view of a pedestal in accordance with one embodiment of the present invention, FIG. 2 illustrates an exploded perspective view of a coupling structure between the pedestal and a washing machine in accordance with another embodiment of the present invention; and FIG. 3 illustrates a cross-sectional view of a part of the washing machine shown in FIG. 2. Hereinafter, components having the same configuration and functions will be denoted by the same reference numerals.

Referring to FIGS. 1 to 3, the pedestal 100 comprises a body 110 to support a product, a guide part 120 positioned on the body 110 to guide the product to a coupling location between the body 110 and the product, and a drawer 150 disposed in the body 110. The product may be, for example, a washing machine or a dryer, and in particular as shown in FIG. 2, a drum washing machine. The washing machine 200 comprises securing legs 220 which are detachably coupled to corresponding coupling holes 232 of the washing machine 200.

Each securing leg 220 serves to support the washing machine 200 while being abutted upon a floor or to couple the washing machine 200 to the pedestal 100 via a coupling aperture 122. In one embodiment, the washing machine 200 is formed with the coupling hole 232 to which the securing leg 220 is coupled. The coupling hole 232 preferably has a thread formed on an inner surface thereof.

In one embodiment, the securing leg 220 comprises a coupling body 220a coupled to the coupling hole 232 and having threads formed thereon, and a support portion 220b formed at the other end of the securing leg 220 so as to be abutted on the floor. The coupling body 220a and the supporting portion 220b may be formed as an integral member or as separate members. In addition, the coupling hole 232 may be formed in a separate leg housing 230 or in a body of the washing machine 200. With this configuration, when coupling the washing machine 200 to the pedestal 100, the securing leg 220 is separated from the coupling hole 232, and then coupled again to the coupling hole 232 (see FIG. 2) through the coupling aperture 122. Meanwhile, the securing leg 220 is preferably formed with a separation groove 222. The separation groove 222 is used to couple or separate the securing leg 220 to or from the coupling hole 232 with a screwdriver.

In another embodiment, the securing leg 220 disposed in the washing machine 200 in a normal state may be inserted into the coupling aperture 122 of the pedestal 100 from above the pedestal 100, and secured to the pedestal 100 by a bolt 225 (see FIG. 1). In this way, the pedestal 100 is primarily coupled to the washing machine 200 via the securing leg 220 passing through the coupling aperture 122. Then, the pedestal 100 is firmly coupled to the washing machine 200 by use of the bolt 225.

The body 110 is coupled to the product, that is, the washing machine 200, to support the washing machine 200, and comprises the guide part 120 and the drawer 150.

The guide part 120 is disposed on the body 110, and serves to guide the washing machine 200 to a coupling location between the washing machine 200 and the pedestal 100. The guide part 120 is formed with the coupling aperture 122 through which the washing machine 200 is coupled to the body 110 of the pedestal 100.

The guide part 120 may comprise a support member 124 which supports the washing machine 200 and guides the washing machine 200 to the coupling location between the washing machine 200 and the pedestal 100. In the embodiments shown in FIGS. 1 and 2, the supporting member 124 is preferably a vibration damping pad capable of absorbing vibration from the washing machine 200. The vibration damping pad may be formed of rubber and the like. The support member 124 of the guide part 120 is formed with the coupling aperture 122 through which the washing machine 200 is coupled to the body 110 of the pedestal.

The drawer 150 is disposed in the body 110 to allow easy installation and movement of the pedestal 100. The drawer 150 is preferably disposed in the body 110 such that the drawer 150 can be separated from the body 110. The drawer preferably has a compartment to receive items.

The washing machine 200 may further comprise a rubber foot 240 to absorb vibration of the washing machine 200 generated when being used on the pedestal 100. In addition, the guide portion 120 has an upper surface configured corresponding to a lower shape of the rubber foot 240. Although not shown in the drawings, it is preferable that the drawer 150 is provided at a lower surface or a side surface with a roller, and that the body 110 is provided with a roller guide corresponding to the roller in order to help a user to attach or detach the drawer to or from the pedestal only with a small force.

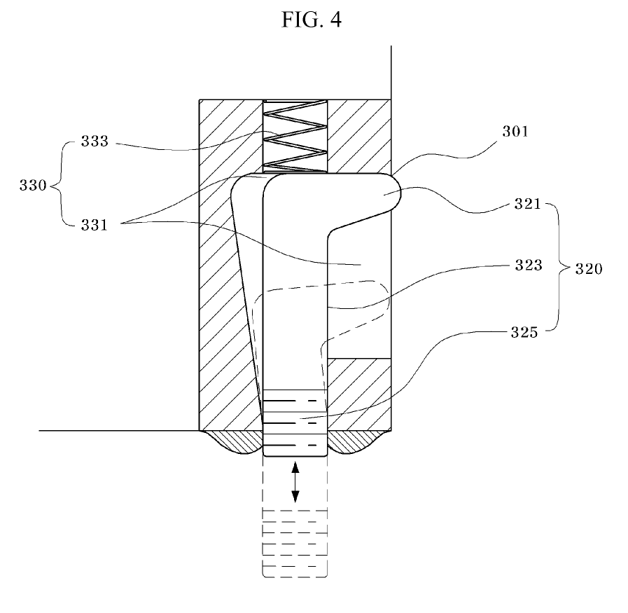

FIG. 4 illustrates a cross-sectional view of a part of a washing machine in accordance with yet another embodiment of the present invention. In FIG. 4, the washing machine according to this embodiment may comprise components which have the same function as that of the above embodiment with respect to the pedestal.

Referring to FIG. 4, the washing machine comprises a securing leg 320 and a leg housing 330. The leg housing 330 is formed with a leg moving hole 331 into which the securing leg 320 is inserted, and provided with a spring 333, of which the upper side is secured to the washing machine. The upper side of the spring 333 is secured to the washing machine by adhesives or a hook (not shown). Since this structure is well known to those skilled in the art, detailed description of the adhesives or the hook is omitted herein.

Additionally, the securing leg 320 comprises a protrusion 321 having a protruding end, a sliding portion 323 having a smooth outer surface to allow easy movement within the leg moving hole 331, and a thread portion 325, which passes through the coupling aperture 122 of the pedestal 100 and is fastened to the bolt 225.

The washing machine can be coupled to the pedestal 100 as follows. Normally, the protrusion 321 is caught by a latch groove 301 of the washing machine, and protruded to the outside of the washing machine, so that the protrusion 321 is secured to the latch groove 301. To mount the washing machine on the pedestal 100, the protrusion 321 is first inserted into the washing machine by compressing the protrusion 321 of the securing leg 320 fixed in the latch groove 301 into the washing machine. When the protrusion 321 is inserted into the leg housing 330, the securing leg 320 is moved downward by force from the spring which has been compressed. With the securing leg 320 moved downward, the thread portion 325 protrudes downward through the coupling aperture 122 of the pedestal. Then, the bolt 225 is fastened to the thread portion 325, mounting the washing machine on the pedestal 100.

Although the washing machine is illustrated as one example of products to which the present invention can be applied, the present invention is not limited to the washing machine.

As apparent from the above description, the pedestal according to the present invention can be firmly coupled to a product to which the pedestal is applied, as compared to conventional cases.

The pedestal of the present invention can also reduce the generation of vibrations and noise in a product to which the pedestal is applied and can extend the life of the product.

Since the pedestal of the present invention can be coupled to a product to which the pedestal is applied, without using an adhesive or the like, it is possible to easily achieve coupling and separation of the pedestal.

Since the pedestal of the present invention uses a detachable drawer, it is possible to easily install and move the pedestal and the product to which the pedestal is applied.

The detachable drawer can be used as a separate receiving compartment.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A pedestal, comprising:
a body coupled to a product to support the product;
a guide part disposed on the body to guide the product to a coupling location between the product and the body; and
a drawer disposed in the body.

2. The pedestal according to claim 1, wherein the guide part includes a coupling aperture through which the body is coupled to the product.

3. The pedestal according to claim 2, further comprising a securing leg to be coupled to the body of the pedestal through the coupling aperture.

4. The pedestal according to claim 2, further comprising a securing leg detachably attached to the product such that the securing leg can be coupled to the product through the coupling aperture after separating the drawer from the body.

5. The pedestal according to claim 1, further comprising a support member to support the product to guide the product to the coupling location between the body and the product.

6. The pedestal according to claim 5, wherein the support member comprises a vibration damping pad to absorb vibration of the product.

7. The pedestal according to claim 5, wherein the support member and the guide part are formed with a coupling aperture through which the body is coupled to the product.

8. The pedestal according to claim 7, further comprising a securing leg coupled to the body of the pedestal through the coupling aperture.

9. The pedestal according to claim 7, further comprising a securing leg detachably attached to the product such that the securing leg can be coupled to the product through the coupling aperture after separating the drawer from the body.

10. A product comprising a pedestal, wherein the pedestal comprises:
a body coupled to a product to support the product;
a guide part disposed on the body to guide the product to a coupling location between the product and the body; and
a drawer disposed in the body.

11. The product according to claim 10, wherein the guide part is formed with a coupling aperture through which the body is coupled to the product.

12. The product according to claim 11, further comprising:
a securing leg to be coupled to the body of the pedestal through the coupling aperture.

13. The product according to claim 11, further comprising:
a securing leg detachably attached to the product such that the securing leg can be coupled to the product through the coupling aperture after separating the drawer from the body.

14. The product according to claim 10, wherein the guide part comprises a support member to support the product to guide the product to the coupling location between the body and the product.

15. The product according to claim 14, wherein the support member comprises a vibration damping pad to absorb vibration of the product.

16. The product according to claim 14, wherein the support member of the guide part is formed with a coupling aperture through which the body is coupled to the product.

17. The product according to claim 16, further comprising:
a securing leg coupled to the body of the pedestal through the coupling aperture.

18. The product according to claim 16, further comprising:
a securing leg detachably attached to the product such that the securing leg can be coupled to the product through the coupling aperture after separating the drawer from the body.

19. The product according to claim 10, wherein the product comprises a washing machine.
